(19) United States
(12) Patent Application Publication
(10) Pub. No.: US 2007/0126728 A1
(43) Pub. Date: Jun. 7, 2007

(54) Power circuit for display and fabrication method thereof

(75) Inventor: Du-Zen Peng, Chubei City (TW)

Correspondence Address: LIU & LIU, 444 S. FLOWER STREET, SUITE 1750, LOS ANGELES, CA, 90071, US

(73) Assignee: Toppoly Optoelectronics Corp.

(21) Appl. No.: 11/295,210

(22) Filed: Dec. 5, 2005

(51) Int. Cl. G09G 5/00

(52) U.S. Cl. 345/211

(57) ABSTRACT

Power circuits for display and fabrication method thereof. The power circuit supplying voltages to a plurality of pixel driving circuits in a display, comprises a power rail and a plurality of pixel power lines. DC voltage is provided externally and conducted by the power rail of first material. The pixel power lines of second material are coupled to the power rail so applying the DC voltage to the pixel driving circuits. The pixel power lines are arranged in parallel, each coupled to a corresponding line of pixel driving circuits. Each of the pixel driving circuits are driven by the DC voltage according to a scan signal and a data signal.

### BACKGROUND OF THE INVENTION

1. Field of the Invention

The invention relates to a power circuit in a display.

2. Description of the Related Art

Active matrix organic light emitting diode (AMOLED) displays are currently popular flat panel display. Compared with an active matrix liquid crystal display (AMLCD), an AMOLED display has many advantages, such as higher contrast ratio, wider viewing angle, thinner profile, low power consumption, and low cost. Unlike an AMLCD display, driven by a voltage source, an AMOLED display requires a current source to drive an electroluminescent (EL) device. The brightness of the EL device is proportional to the current conducted thereby. Variations in current, however, seriously impact uniformity of the AMOLED display.

FIG. 1 shows a conventional power circuit 100 for use in a display. A matrix of pixel driving circuits in the display is powered by the power circuit 100. The power circuit 100 comprises a power rail 102 and a plurality of pixel power lines 104 arranged in parallel. A fixed DC voltage is provided externally (not shown) to the power rail 102. The power rail 102 and pixel power line 104 are composed of Mo/Al/Mo stacked layer, conducting the DC voltage to the matrix of pixel driving circuits (not shown).

FIG. 2 shows the equivalent circuit 200 of the power circuit 100. The equivalent resistance of power rail 102 and pixel power line 104 are shown as power rail 202 and pixel power line 204. Current is fed to the pixel power line 204 through power rail 202, and as a result, DC voltage drops before reaching the pixel driving circuits, significantly impacting uniformity of the AMOLED display.

### BRIEF SUMMARY OF INVENTION

An embodiment of the present invention provides a power circuit supplying voltages to a plurality of pixel driving circuits in a display, comprises a power rail and a plurality of pixel power lines that are formed by different materials. DC voltage is provided to the power rail comprising a first material with a first electrical conductivity. The pixel power lines composed of a second material with a second electrical conductivity are coupled to the power rail so applying the DC voltage to the pixel driving circuits. The pixel power lines coupled to a corresponding line of pixel driving circuits. Each of the pixel driving circuits is driven by the DC voltage according to a scan signal and a data signal.

In another embodiment of the present invention, a display panel comprises the power circuit described, a pixel array, a gate driver and a source driver. The pixel array comprises a pixel driving circuit with voltage compensation to minimize the effect of voltage drops of power lines and transistors threshold voltage variations.

Further an embodiment discloses a plurality of pixel power lines composed of Mo/Al/Mo laminated structure and arranged in parallel on the substrate. A power rail with Cu or Ag on the substrate is formed, having a pattern partially overlapping the pixel power lines and connection pads to conduct a DC voltage fed externally to the pixel power lines.

### BRIEF DESCRIPTION OF THE DRAWINGS

The following detailed description, given by way of example and not intended to limit the invention solely to the embodiments described herein, will best be understood in conjunction with the accompanying drawings, in which:

FIG. 1 shows a conventional power circuit for a display;

FIG. 2 shows an equivalent circuit of FIG. 1;

FIG. 3a shows an embodiment of a power circuit;

FIG. 3b shows another embodiment of the power circuit;

FIG. 3c shows an embodiment of a display panel;

FIG. 4 shows a sectional view taken along line 4-4 in FIG. 3c, which illustrates a power circuit in accordance with one embodiment of the present invention;

FIG. 5a shows an embodiment of a pixel driving circuit;

FIG. 5b shows a timing sequence of the signals in FIG. 5a;

FIG. 6 is a schematic diagram of a display device comprising the display panel in accordance with one embodiment of the present invention;

FIG. 7 is a schematic diagram of an electronic device, incorporating a display comprising the display device in accordance with one embodiment of the present invention.

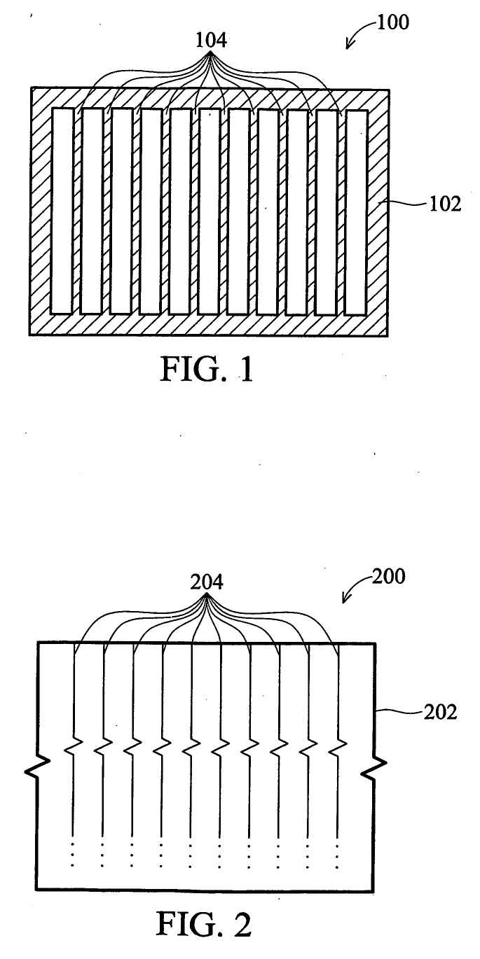

### DETAILED DESCRIPTION OF THE INVENTION

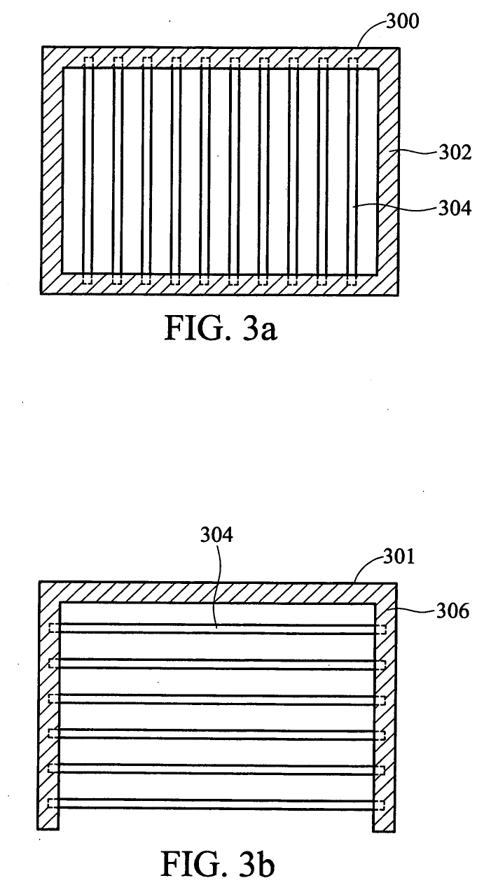

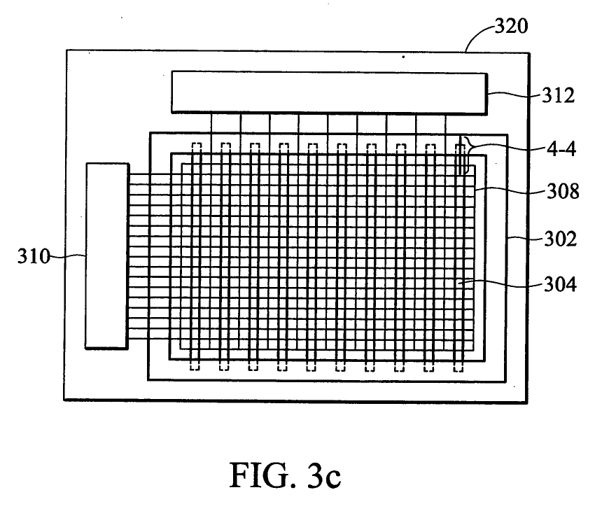

FIG. 3a shows an embodiment of a power circuit 300 supplying voltages to a plurality of pixel driving circuits in a display (not shown). The power circuit 300 comprises a power rail 302 and a plurality of pixel power lines 304. The power rail 302 can be composed of a first material, conducts a fixed DC voltage provided externally to the display. The pixel power lines 304 can be composed of a second material coupled to the power rail 302 to apply the DC voltage to each pixel driving circuit. The first material has first electrical conductivity, and the second material has second electrical conductivity, wherein the first electrical conductivity is higher than the second electrical conductivity. Since electrical conductivity of the power rail 302 is higher than electrical conductivity of the power lines 304, voltage drop thereon is greatly reduced.

The relative electrical conductivity with reference to Copper (Cu) are shown:

Ag 106%, Cu 100%, A161%, and Mo 36.1%. Therefore the compound metal of Cu and Ag has greater conductivity than that of Mo and Al, ranging from 1.6 to 3.2 times. Since the electrical conductivity of Cu and Ag is 1.6 to 3.2 times higher than the Mo and Al DC voltage drops before reaching the pixel driving circuits can be reduced, and uniformity of the AMOLED display can be improved. The first material can be Cu, Ag or combination thereof, and the second material can be Mo, Al or Mo/Al/Mo laminated structure. As shown in FIG. 3a, the pixel power lines 304 are arranged in parallel. In this case, the pixel power lines 304 are arranged vertically, and alternatively, an embodiment of horizontal arrangement is also applicable.

FIG. 3b shows another embodiment of a power circuit, in which the power lines 304 are horizontally arranged, and the power rail 306 is a reversed “U” design for further panel fabrication. The panel fabrication is known in the art and detailed description can be omitted herein.

FIG. 3c shows an embodiment of a display panel 320, comprising a power circuit, a pixel array 308, a gate driver 310 and a source driver 312. The power circuit comprises a power rail 302 disposed on periphery of the pixel array 308 and a plurality of power lines 304 disposed on internal of the pixel array 308. The pixel array 308 comprises a plurality of pixel driving circuits, such as a plurality of thin film transistors, a plurality of scan lines and data lines, each driven by the DC voltage provided by the power circuit 300. The pixel driving circuits are well known to those skilled in the art and further description is omitted here. The gate driver 310 provides scan signals to the pixel array 308, and the source driver 312 provides data signals to the pixel array 308. The pixel power lines 304 are arranged in parallel, each coupled to a corresponding line of the pixel array 308, with each of the pixel driving circuits in the pixel array 308 driven by the DC voltage to emit light according to the scan signal provided from gate driver 310 and the data signal provided from source driver 312.

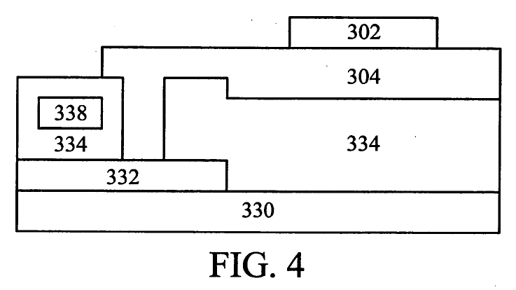

FIG. 4 shows a schematic sectional view taken along line 4-4 in FIG. 3c (some of the details of the structure shown in FIG. 4 are not shown in the plan view of FIG. 3c), illustrates the power circuit in accordance with one embodiment of the present invention. In FIG. 4, a semiconductor layer 332 such as a Poly-Si layer, insulating layer 334, gate layer 338 and power line 304 are formed on a substrate 330. The semiconductor layer 332, insulating layer 334 and gate layer 338 forming conventional pixel implementations, with formation thereof not described herein. The first metal of the power line 304 that can be Mo and Al is formed on insulating layer and is connected to the semiconductor layer 332. A patterned power rail 302, such as Cu, Ag or combination thereof, is formed on the power line 304. An insulating film (not shown) such as silicon oxide or silicon nitride also can be formed between the patterned power rail 302 and the power line 304.

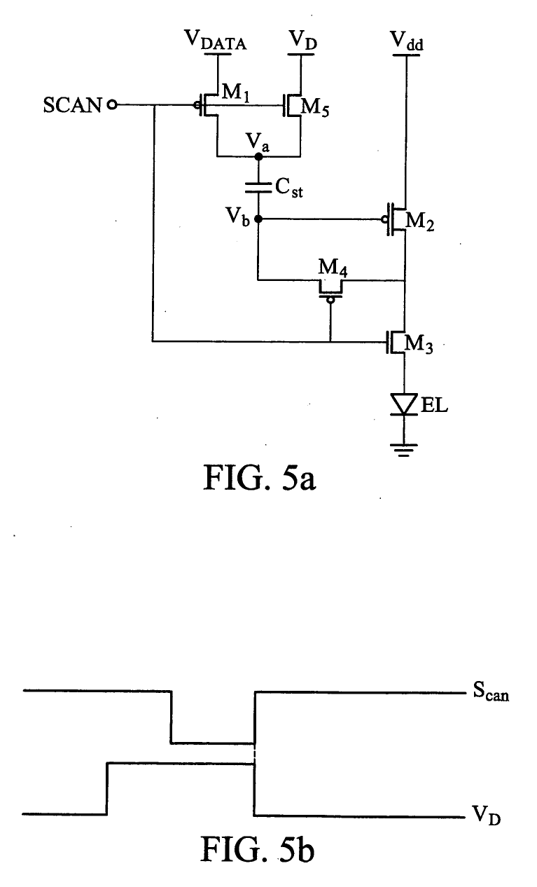

According to various embodiments, a pixel driving circuit with voltage compensation to further minimize the effect of voltage drops of power lines and transistors threshold voltage variations is provided. FIG. 5a shows an embodiment of a pixel driving circuit. In the circuit, the V_{dd} is coupled to corresponding pixel power line 304 in FIG. 3c. The pixel driving circuit in FIG. 5a comprises a storage capacitor Cst with nodes Va and Vb. A multiplexing circuit M1 is coupled to the node Va for transferring the data signal to the node Va when a first scan signal is de-asserted and a variable reference signal to the node Va when a second scan signal is asserted. A reference signal generator M5 is coupled to the multiplexing circuit M1 generating the variable reference signal. A transistor M2 (such as a diode-connected driver) is coupled to the node Vb, and the transistor M2 couples the DC voltage V_{dd} and a threshold voltage Vₜₕ of the transistor M2 therein from one of the pixel power lines to the node Vb when the first scan signal is de-asserted (as the falling edge of the scan signal SCAN in FIG. 5b) and the second scan signal is asserted (as the rising edge of the scan signal SCAN in FIG. 5b). A switching element M3 is coupled to the transistor M2, providing a driving current from the DC voltage V_{dd}, via the transistor M2, to an EL device when the first scan signal is asserted.

FIG. 5b is a timing diagram of the scan signal SCAN and the reference signal V_{D}. When the scan signal SCAN is pulled low, transistors M1 and M4 are opened, and transistors M3 and M5 are closed. The potential at node Va is V_{DATA}, and at node Vb is V_{dd}-Vₜₕ, where Vₜₕ is the threshold voltage of the transistor M2. When the scan signal SCAN is pulled high, the transistors M1 and M4 are closed, and the transistors M3 and M5 are opened. Thus the potential at Va is 0, and the potential at Vb is V_{dd}−V_{DATA}+Vₜₕ. The electrical current flowing through the EL device is therefore derived as follows:

$$I \begin{matrix}= {K ( {V}_{dd} - Vb - {V}_{th} )}^{2} \\ = {K ( {V}_{dd} - {V}_{dd} + {V}_{DATA} - {V}_{th} + {V}_{th} )}^{2} \\ = {KV}_{DATA}^{2}\end{matrix}$$

Thus, the current through the EL device is independent of the threshold voltage Vₜₕ of the transistor M2 as well as the DC voltage V_{dd}.

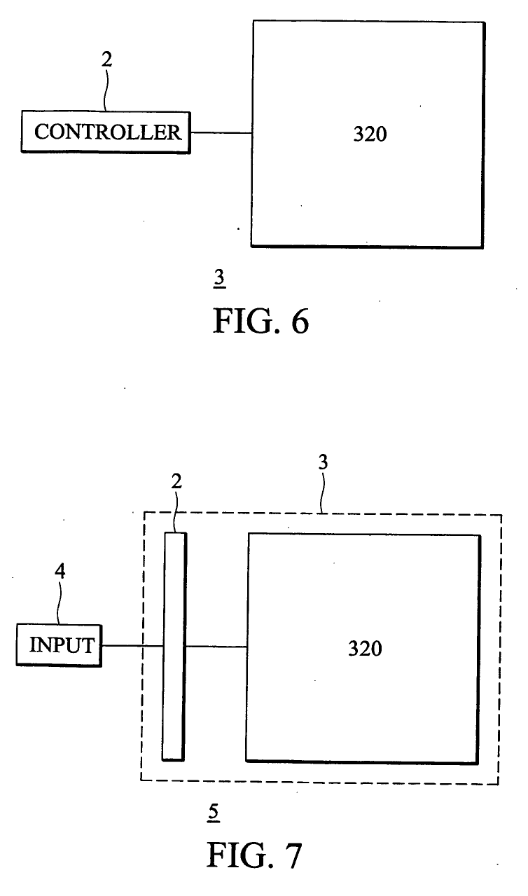

FIG. 6 is a schematic diagram of a display device 3 comprising the display panel in accordance with one embodiment of the present invention. The display panel 320 such as shown in FIG. 3c can be couple to a controller 2 to control the display panel 320 to render image in accordance with an image data.

FIG. 7 is a schematic diagram of an electronic device 5, incorporating a display comprising the display device in accordance with one embodiment of the present invention. An input device 4 is coupled to the controller 2 of the display device 3 shown in FIG. 6, which can include a processor or the like to input data to the controller 2 to render an image. The electronic device 5 may be a portable device such as a PDA, notebook computer, tablet computer, cellular phone, or a desktop computer.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power circuit supplying voltage to a plurality of pixel driving circuits in a display, comprising:
a power rail comprising a first conductive material disposed on peripheral of a pixel array of the display; and
a plurality of pixel power lines comprising a second conductive material, the pixel power lines disposed on internal of the pixel array and coupled to the power rail; wherein:
the first conductive material is different from the second conductive material and the electrical conductivity of the first material is higher than thereof the second material.

2. The power circuit as claimed in claim 1, wherein the electrical conductivity of the first material is 1.6 to 3.2 times higher than that of the second material.

3. The power circuit as claimed in claim 1, wherein
the first material is Cu, Ag or combination thereof.

4. The power circuit as claimed in claim 1, wherein the second material is Mo, Al or Mo/Al/Mo laminated structure.

5. The power circuit as claimed in claim 1, wherein the pixel power lines are arranged vertically, and the power rail has a pattern partially overlapping the pixel power lines and forming a loop.

6. The power circuit as claimed in claim 1, wherein the pixel power lines are arranged horizontally, and the power rail has a pattern partially overlapping the pixel power lines and forming a U shape.

7. The power circuit as claimed in claim 1, wherein:
the pixel power lines are arranged in parallel, each coupled to a corresponding line of pixel driving circuits; and
each of the pixel driving circuits are driven by the DC voltage according to a scan signal and a data signal.

8. The power circuit as claimed in claim 7, wherein the pixel driving circuits with voltage compensation to minimize the effect of voltage drops of power lines and transistors threshold voltage variations, each comprising:
a storage capacitor with a first and second node;
a multiplexing circuit coupled to the first node of the storage capacitor, the multiplexing circuit transferring the data signal to the first node of the storage capacitor when a first scan signal is de-asserted and transferring a variable reference signal to the first node of the storage capacitor when a second scan signal is asserted;
a reference signal generator coupled to the multiplexing circuit generating the variable reference signal;
a diode-connected driver coupled to the second node of the storage capacitor, the diode-connected driver coupling the DC voltage and a threshold voltage of a first transistor therein from one of the pixel power lines to the second node of the storage capacitor when the first scan signal is de-asserted and the second scan signal is asserted; and
a switching element coupled to the diode-connected driver, the switching element providing a driving current from the DC voltage, via the first transistor in the diode-connected driver, to a display when the first scan signal is asserted.

9. A display device, comprising:
a power circuit as claimed in claim 1, supplying a DC voltage to a plurality of pixel driving circuits;
a pixel array comprising the pixel driving circuits;
a gate driver providing scan signals to the pixel array; and
a source driver providing data signals to the pixel array.

10. The display device as claimed in claim 9, wherein the first material is a Cu, Ag or combination thereof.

11. The display device as claimed in claim 9, wherein the second material is Mo, Al or Mo/Al/Mo laminated structure.

12. An electronic device, comprising:
a display device as claimed in claim 9;
a power supply generating the DC voltage to the power circuit; and
an input device providing image data to the display device to render an image.

13. The electronic device as claimed in claim 12, wherein the first material is a Cu, Ag or combination thereof.

14. The electronic device as claimed in claim 12, wherein the second material is Mo, Al or Mo/Al/Mo laminated structure.

15. A power circuit distributing power to an array of drive circuits in a display, comprising:
a power rail having a first longitudinal electrical conductive section spanning coverage of at least one dimension of the array of drive circuits, the first longitudinal conductive section has a first defined characteristic cross-section of a first material;
a plurality of pixel power lines coupled to the power rail, each having a second longitudinal electrical conductive section spanning coverage of at least one row of drive circuits, the second longitudinal section has a second defined characteristic cross-section of a second material; wherein the electrical conductivity of the first material is higher than that of the second material.

16. The power circuit as in claim 15, wherein at least one of the first and second materials comprises more than one metallic material.

17. A method of distributing power to an array of drive circuits in a display, comprising:
providing a power circuit as in claim 15;
providing DC power to the power circuit.
